(19) United States
(12) Patent Application Publication
(10) Pub. No.: US 2025/0195994 A1
(43) Pub. Date: Jun. 19, 2025

(54) GAME MACHINE, GAME-MACHINE PROGRAM, AND RECORDING MEDIUM STORING GAME-MACHINE PROGRAM

(71) Applicant: ALPS ALPINE CO., LTD., Tokyo (JP)

(72) Inventors: Takayuki OHASHI, Miyagi (JP); Tetsu NUMATA, Miyagi (JP); Tetsuo MURANAKA, Miyagi (JP); Masaki OTA, Miyagi (JP); Yasuji HAGIWARA, Miyagi (JP); Yasuo KOTERA, Miyagi (JP)

(21) Appl. No.: 18/949,312

(22) Filed: Nov. 15, 2024

(30) Foreign Application Priority Data
Dec. 13, 2023 (JP) 2023-210259

(51) Int. Cl. A63F 13/218; A63F 13/214; A63F 13/807

(52) U.S. Cl. CPC A63F 13/218; A63F 13/214; A63F 13/807

(57) ABSTRACT

A game machine includes: an operation part including an operation surface on which an operation is performed by an operator; a signal output part to output an output signal in accordance with an operation position to which an operation is performed on the operation surface, and magnitude and direction of load applied to the operation part; an operation-position detector to detect the operation position in accordance with one or more of output signals, each being the output signal, output from the signal output part; a load detector to detect the magnitude and the direction of the load applied to the operation part in accordance with one or more of the output signals output from the signal output part; a processor to calculate state of an object arranged in a game space; and a storage to store control data associating operation contents by the operator with the state of the object.

### CROSS-REFERENCE TO RELATED APPLICATIONS

The present application is based on and claims priority to Japanese Patent Application No. 2023-210259 filed on Dec. 13, 2023, the entire contents of which are hereby incorporated by reference.

### BACKGROUND

### 1. Field of the Invention

The present disclosure relates to a game machine, a game-machine program, and a recording medium storing the game-machine program.

### 2. Description of the Related Art

Conventionally, a game device configured to display and control a player character arranged in a game space to execute a predetermined game is provided with: a measurement part configured to measure a load such as a weight of a player; a static-load determination means for determining a static load from a measured value of the measurement part; a change detection means for detecting an instantaneous and alternate change in the measured value reaching both an increase-amount threshold value and a decrease-amount threshold value from the static load determined by the static-load determination means; and a motion control means for causing the player character to perform a predetermined motion that is predetermined as a motion to be performed at the time of a detection by the change detection means according to the detection. The measurement part includes a plurality of pressure sensors provided at different positions, and is configured to control a movement direction of the predetermined motion of the player character by using load balance for detecting a load balance by using detection results from each of the plurality of pressure sensors (for example, see Japanese Laid-Open Patent Application No. 2010-082340).

### SUMMARY

A game machine according to one embodiment of the present disclosure includes: an operation part that includes an operation surface on which an operation is performed by an operator; a signal output part configured to output an output signal in accordance with an operation position to which an operation is performed on the operation surface, and a magnitude and a direction of a load applied to the operation part; an operation-position detector configured to detect the operation position in accordance with the output signal output from the signal output part; a load detector configured to detect the magnitude and the direction of the load applied to the operation part in accordance with the output signal output from the signal output part; a processor configured to calculate a state of an object arranged in a game space; and a storage configured to store control data associating operation contents by the operator with the state of the object, wherein the processor calculates the state of the object by referencing the control data, in accordance with the operation position detected by the operation-position detector, the magnitude and the direction of the load detected by the load detector, and the state of the object.

### BRIEF DESCRIPTION OF THE DRAWINGS

FIG. 1 is an external perspective view of a game controller of a game machine according to one embodiment;

FIG. 2 is an exploded perspective view of the game controller according to the embodiment as viewed from the top;

FIG. 3 is an exploded perspective view of the game controller according to the embodiment as viewed from the bottom;

FIG. 4 is a circuit diagram of a rotational-operation detecting circuit 241 included in a force sensor according to the embodiment;

FIG. 5 is a circuit diagram of a tilting-operation detecting circuit 242 included in the force sensor according to the embodiment;

FIG. 6 is a diagram illustrating an example configuration of a game machine according to the embodiment;

FIG. 7A is a flowchart illustrating an example of state transitions when operating a player character's longitudinal posture;

FIG. 7B is a flowchart illustrating an example of state transitions when operating a player character's posture in a skateboard's longitudinal direction;

FIG. 7C is a diagram illustrating an example of four operation positions on an operation surface 120B for operating the skateboard tilting;

FIG. 7D is a flowchart illustrating an example of control of a jumping motion;

FIG. 7E is a diagram illustrating an example of posture control of a player character by a rotational operation;

FIG. 8A is a diagram illustrating an example 1 of a player character motion;

FIG. 8B is a diagram illustrating a specific example 1 of a motion of the player character;

FIG. 8C is a diagram illustrating the specific example 1 of the motion of the player character;

FIG. 8D is a diagram illustrating the specific example 1 of the motion of the player character;

FIG. 9A is a diagram for describing a specific example 2 of the motion of the player character; and

FIG. 9B is a diagram for describing the specific example 2 of the motion of the player character.

### DETAILED DESCRIPTION OF THE DISCLOSURE

An existing game device is configured to merely control the motion of a player character based on the change in the load or the load balance by using the measurement part configured to measure the load such as a weight of the player. Therefore, there are few input means for operating the motion of an object such as a player character, and it has been difficult to create a game rich in variations.

A game machine, which provides various input means for operating the motion of the object and can achieve a game rich in variations, a game-machine program, and a recording medium storing the game-machine program, are provided.

In the following, an embodiment in which a game machine, a game-machine program, and a recording medium to which the program for a game machine is stored are applied will be described.

Hereinafter, one embodiment will be described. In the following description, for convenience, an X-axis direction in the drawings is referred to as a front-rear direction, a Y-axis direction in the drawings is referred to as a left-right direction, and a Z-axis direction in the drawings is referred to as a vertical direction. However, a positive X-axis direction is referred to as a forward direction, a positive Y-axis direction is referred to as a right direction, and a positive Z-axis direction is referred to as an upward direction. These represent a relative positional relationship within a device, and are not intended to limit an installation direction or an operating direction of the device, and all devices having the same relative positional relationship within the device, even those having different installation directions or operating directions, are included in the scope of the present disclosure.

### Outline of Game Controller 100 of Game Machine of One Embodiment

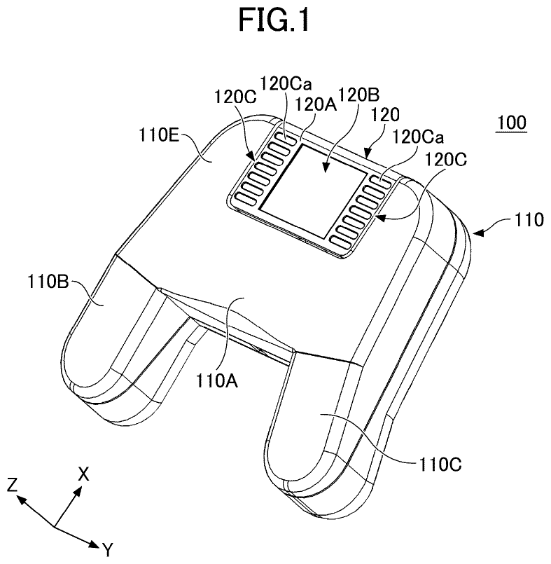

FIG. 1 is an external perspective view of a game controller 100 of a game machine according to one embodiment. The game controller 100 as illustrated in FIG. 1 is operated by, for example, an operator (i.e., a player of the game) of the game machine.

As illustrated in FIG. 1, the game controller 100 includes a casing 110. The casing 110 is a resin member forming an outer shape of the game controller 100.

The casing 110 includes a central portion 110A, a left grip portion 110B provided on a left side (a negative Y-axis side) of the central portion 110A, and a right grip portion 110C provided on a right side (a positive Y-axis side) of the central portion 110A. The left grip portion 110B and the right grip portion 110C are longer in the front-rear direction (X-axis direction) than the central portion 110A and have shapes projecting rearward (a negative X-axis direction) from a rear surface of the central portion 110A.

Thus, the casing 110 has a shape in which the operator can easily grip the left grip portion 110B with his or her left hand and the right grip portion 110C with his or her right hand.

A front end (end of a positive X-axis side) of the central portion 110A of the casing 110 is formed with a recess 110D recessed downward (a negative Z-axis direction) from an upper surface 110E of the casing. The game controller 100 includes a touchpad unit 120 in the recess 110D of the casing 110. The touchpad unit 120 is an example of the operation part.

In a plan view seen from above (the positive Z-axis direction), both the recess 110D and the touchpad unit 120 have a rectangular shape with the left-right direction (Y-axis direction) as a longitudinal direction. The rectangular shape formed by the touchpad unit 120 is smaller than the rectangular shape formed by the recess 110D of an upper casing 111. Thus, a space is provided between an outer periphery of the touchpad unit 120 and an inner periphery of the recess 110D.

The upper surface 110E (surface on a positive Z-axis side) of the casing 110 and an upper surface 120A (surface on the positive Z-axis side) of the touchpad unit 120 are provided on a same plane.

The touchpad unit 120 includes a rectangular operation surface 120B on the upper surface 120A (surface on the positive Z-axis side) with the left-right direction (Y-axis direction) as the longitudinal direction. In the touchpad unit 120, an operator can perform a touch operation on the operation surface 120B.

The touchpad unit 120 is displaceable with respect to the casing 110, and receives a pressing operation, a tilting operation, and a rotational operation by an operator.

The pressing operation of the touchpad unit 120 is an operation of pushing a central portion of the operation surface 120B of the touchpad unit 120 downward (negative Z-axis direction). By the pressing operation, a compressive load is applied downward (in the negative Z-axis direction) while keeping the touchpad unit 120 in a horizontal state. When a load is applied in the negative Z-axis direction, it is regarded as a pressing operation. For example, even when the left and right sides of the operation surface 120B of the touchpad unit 120 are pressed equally, it is regarded as a pressing operation.

The tilting operation of the touchpad unit 120 is an operation to push a peripheral portion (a portion other than the central portion) of the operation surface 120B of the touchpad unit 120 downward (in the negative Z-axis direction). By the tilting operation, a bending load is applied to the touchpad unit 120 with respect to the central axis passing through the center of the touchpad unit 120 (a central axis parallel to the Z-axis).

The rotational operation of the touchpad unit 120 is an operation to twist the touchpad unit 120 about the central axis passing through the center of the touchpad unit 120 (the central axis parallel to the Z-axis). By the rotational operation, a torsional load is applied to the touchpad unit 120 about the central axis passing through the center of the touchpad unit 120 (the central axis parallel to the Z-axis).

In addition to the touchpad unit 120, the game controller 100 is generally provided with other input devices such as a plurality of buttons and an analog stick, but the illustration and description of these other input devices are omitted in the present document.

### Configuration of Game Controller 100

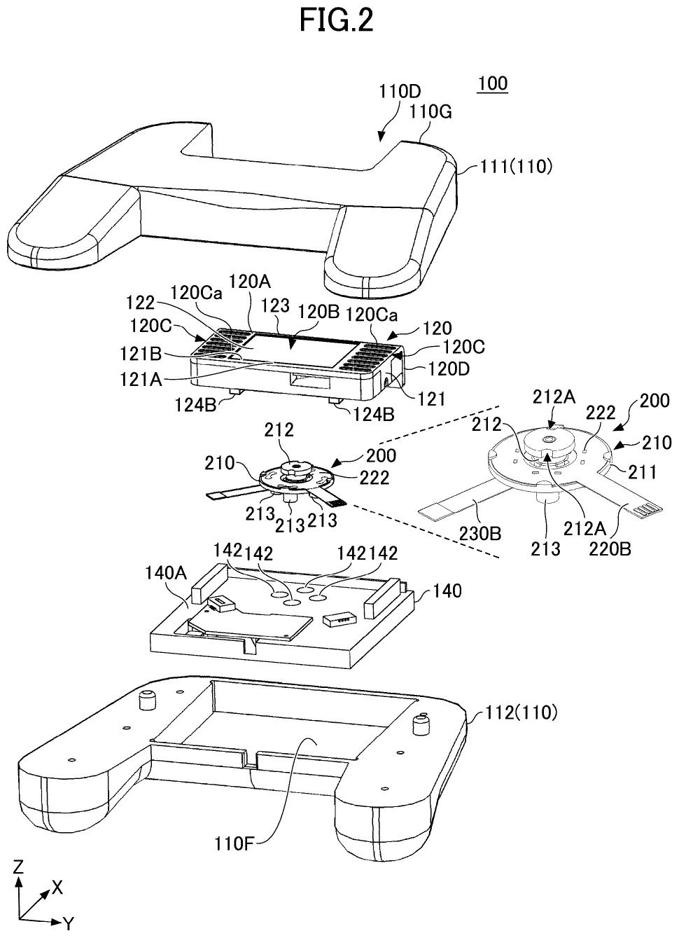

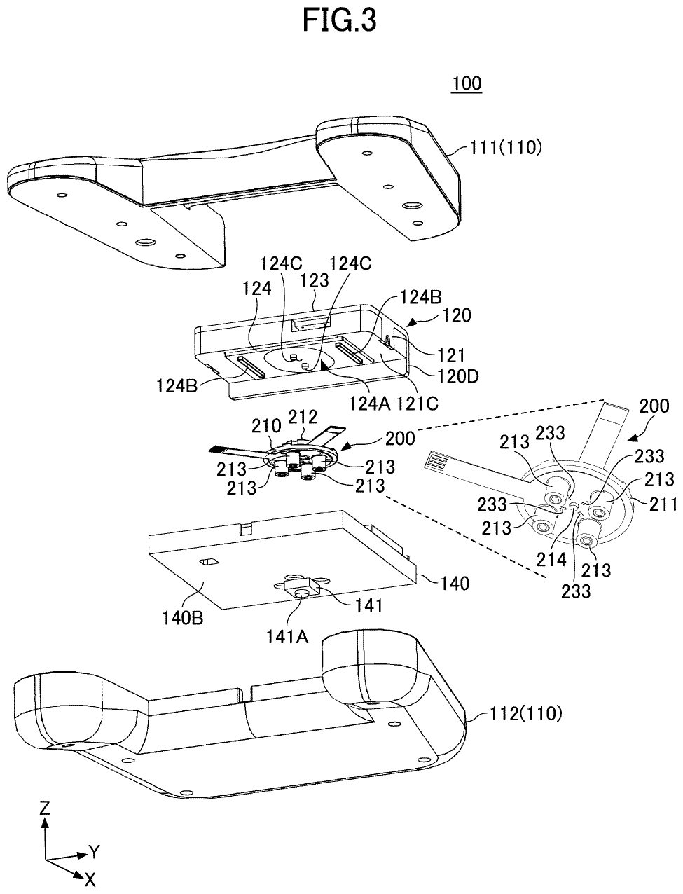

FIG. 2 is an exploded perspective view of the game controller 100 according to one embodiment as viewed from above (the positive Z-axis direction). FIG. 3 is an exploded perspective view of the game controller 100 according to the embodiment as viewed from below (the negative Z-axis direction).

As illustrated in FIGS. 2 and 3, the game controller 100 includes the casing 110, the touchpad unit 120, a force sensor 200, and a substrate 140. The force sensor 200 is illustrated enlarged on a right side of FIGS. 2 and 3.

The casing 110 is a member that forms an outer shape of the game controller 100 and supports other components. The casing 110 is formed of a relatively hard resin material. The casing 110 includes the upper casing 111 constituting an upper (the positive Z-axis side) portion of the casing 110 and a lower casing 112 constituting a lower (a negative Z-axis side) portion of the casing 110. In the casing 110, the upper casing 111 and the lower casing 112 are screwed together to fix them in a state they are mutually connected. That is, the casing 110 can be divided into two portions, the upper casing 111 and the lower casing 112 by releasing the screw fixing. A front portion (portion on the positive X-axis side) of the upper casing 111 is U-shaped when viewed from the upper side (positive Z-axis side). The recess 110D is a center portion of the U-shaped portion of the upper casing 111. The recess 110D is a recess including a bottom surface in the lower casing 112. A width of the recess 110D of the upper casing 111 is narrower than the width of the recess 110D of the lower casing 112.

The touchpad unit 120 includes a holder 121, a touchpad 122, a cover plate 123, and an operation plate 124.

The holder 121 is a resin member for holding the touchpad 122 and the cover plate 123. The holder 121 has a thin rectangular shape in the vertical direction (Z-axis direction). The holder 121 has a rectangular shape with a left-right direction (Y-axis direction) as a longitudinal direction in a plan view when viewed from above (positive Z-axis direction). The holder 121 includes a recess 121B recessed downward (negative Z-axis direction) from an upper surface 121A of the holder 121. The recess 121B has a rectangular shape with a left-right direction (Y-axis direction) as a longitudinal direction in a plan view when viewed from above (positive Z-axis direction). The touchpad 122 is arranged inside the recess 121B.

The touchpad 122 is a horizontal flat plate device for detecting a touch operation to the operation surface 120B by an operator's finger. For example, the touchpad 122 includes a resin flat-plate circuit board and a sheet electrostatic sensor provided on an upper surface of the circuit board. The touchpad 122 detects a contact position of the operator's finger on the operation surface 120B by the electrostatic sensor. The touchpad 122 is arranged in a horizontal orientation in the recess 121B of the holder 121. When the touchpad 122 is arranged in the recess 121B of the holder 121, the upper surface 122A of the touchpad 122 is on a same plane with the upper surface 121A of the holder 121.

The cover plate 123 is a horizontal plate member. The cover plate 123 is in a stacked arrangement with the upper surface 121A of the holder 121 to cover the upper surface 121A of the holder 121 and the upper surface 122A of the touchpad 122. The cover plate 123 is formed of a hard material (for example, resin, glass, etc.). In the present embodiment, as an example, the cover plate 123 has a rectangular shape having the same shape as that of the holder 121 in a plan view seen from above (the positive Z-axis direction). The upper surface of the cover plate 123 serves as the operation surface 120B of the touchpad unit 120.

The operation plate 124 is a horizontal flat plate member. The operation plate 124 is provided to overlap the lower surface 121C of the holder 121 and is fixed to the lower surface 121C of the holder 121. The operation plate 124 is formed of a hard material (for example, resin materials, metal materials, etc.). In the present embodiment, as an example, the operation plate 124 has a rectangular shape with a left-right direction (the Y-axis direction) as the longitudinal direction in a plan view seen from the lower side (the negative Z-axis direction). The operation plate 124 includes a fixing portion 124A to which the force sensor 200 (a first support 212 to be described in the following) is fixed, at the center of a lower surface of the operation plate 124. Projections 124C of the fixing portion 124A is fixed to recesses 212A of the first support 212. The operation plate 124 is fixed to the substrate 140 via the force sensor 200.

The operation plate 124 includes a stopper 124B provided along a short side of the operation plate 124, at both right and left ends of the lower surface of the operation plate 124. The stoppers 124B contact an upper surface 140A of the substrate 140 when the operation plate 124 is tilted by a predetermined angle with respect to the substrate 140, thereby restricting the amount of displacement (tilt angle) of the operation plate 124. The stoppers 124B may be provided on the upper surface 140A of the substrate 140.

The touchpad unit 120 configured as described above is arranged in the recess 110D formed in the upper casing 111 of the casing 110. The touchpad unit 120 is fixed to the substrate 140 via the fixing portion 124A of the operation plate 124 and the force sensor 200 (the first support 212 described in the following). Thus, the touchpad unit 120 is displaceably supported by the force sensor 200 in the recess 110D of the casing 110, and the force sensor 200 can be operated.

The touchpad unit 120 is an example of the “operation part”. The touchpad unit 120 includes a pair of left and right anti-slip portions 120C near the left and right ends on the upper surface 120A of the touchpad unit 120. In the present embodiment, the anti-slip portions 120C include projections each having an elliptical shape in a plan view. In the present embodiment, the anti-slip portions 120C are provided integrally with the cover plate 123 of the touchpad unit 120.

Each of the pair of left and right anti-slip portions 120C includes a plurality of grooves 120Ca, each groove extending in the left-right direction (the Y-axis direction). The plurality of grooves 120Ca are arranged side by side in the front-rear direction (the X-axis direction). Each of the plurality of grooves 120Ca has a shape recessed downward (in the negative Z-axis direction) from the upper surface 120A, and has an elliptical shape with the left-right direction (the Y-axis direction) as the longitudinal direction.

Since each of the plurality of grooves 120Ca has the recessed shape and elliptical shape as described above, the game controller 100 can enhance the anti-slip effect of the operator's thumb in the front-rear direction (the X-axis direction). Further, since the plurality of grooves 120Ca are arranged side by side in the front-rear direction (the X-axis direction), the game controller 100 can obtain the anti-slip effect of the operator's thumb over a wide range in the front-rear direction (the X-axis direction).

A sensor electrode of the touchpad 122 is also provided at positions overlapping with the anti-slip portions 120C, in other words, a pair of left and right anti-slip portions 120C are provided on the touchpad 122. Thus, the game controller 100 according to one embodiment can effectively use the entire upper surface of the touchpad unit 120 including the pair of left and right anti-slip portions 120C as a touch operation area, and can detect the positions of fingers over a wide range.

The anti-slip portions 120C are provided at positions that can be caught with the thumbs of the operator's hands while the operator holds the game controller 100 with both hands. The anti-slip portions 120C can be caught with the thumbs of the operator's hands, so that the operator can easily perform the operation of applying a load to the touchpad unit 120 while holding the game controller 100 with both hands. When a force is applied in the front-rear direction by moving the left and right thumbs in opposite directions, a torsional load (rotational operation) can be detected. When either of the left and right thumbs is pushed down, a bending load (tilting operation) can be detected. The bending load (tilting operation) can also be detected when the front of the touchpad unit 120 is pushed down by the left or right thumb or both, and when the rear of the touchpad unit 120 is pushed down by the left or right thumb or both. The torsional load (torque) due to the rotational operation, the bending load due to the tilting operation in the left-right direction, and the bending load due to the tilting operation in the front-rear direction are all moments with the center of the touchpad unit 120 as the center point. In other words, each of these loads is the product of the operator's pushing strength and a distance from the center of the touchpad unit 120 to a position pushed by the operator.

The touchpad unit 120 is provided in the recess 110D of the casing 110, and a front side (the positive X-axis side) surface 120D of the touchpad unit 120 is provided on a same plane as a front side (the positive X-axis side) surface 110G of the casing 110.

As described above, the touchpad unit 120 includes an electrostatic touchpad 122. In the touchpad unit 120, the touchpad 122 is provided between the pair of left and right anti-slip portions 120C.

The shape, number, and positions of the anti-slip portions 120C are not limited to those illustrated in the present embodiment. The anti-slip portions 120C may be provided separately from the cover plate 123 and attached to the cover plate 123.

The force sensor 200 is provided on the lower side (the negative Z-axis side) of the touchpad unit 120 and on the upper side (positive Z-axis side) of the substrate 140, in the recess 110D of the casing 110. The force sensor 200 detects the displacement of the touchpad unit 120. Specifically, the force sensor 200 includes a strain generator 210, and is fixed to the operation plate 124 of the touchpad unit 120 at the first support 212 of the strain generator 210, and is fixed to the substrate 140 at four second supports 213 of the strain generator 210. Thus, when the touchpad unit 120 is operated (tilting, rotational, and pressing operations), the force sensor 200 can detect distortion of the strain generator 210 by a plurality of strain sensors 222, 233 (an example of a strain resistor) provided in the strain generator 210. The first support 212 is fixed to the center of the touchpad unit 120. Therefore, a force of pressing the left and right ends of the touchpad unit 120 in opposite directions in the front-rear direction (the positive X-axis direction and the negative X-axis direction), generates a torsional load and is detected as a rotational operation. A force of pressing one end of the touchpad unit 120 downward (in the negative Z-axis direction) generates a bending load and is detected as a tilting operation. A force of pressing the both ends of the touchpad unit 120 downward (in the negative Z-axis direction) generates a compressive load and is detected as a pressing operation.

The substrate 140 is a flat plate member made of resin. The substrate 140 has a rectangular shape with a left-right direction (the Y-axis direction) as a longitudinal direction in a plan view seen from above (the positive Z-axis direction). The width (a length in the Y-axis direction) of the substrate 140 is narrower than that of the recess 110D of the lower casing 112. The width (the length in the Y-axis direction) of the substrate 140 is wider than that of the recess 110D of the upper casing 111. Therefore, the substrate 140 can be moved in the recess 110D of the lower casing 112. Due to a restoring force of the press portion 141A of the push switch 141, the left and right ends of the upper surface of the substrate 140 are in contact with the upper casing 111. When the restoring force of the press portion 141A of the push switch 141 is weak, a compression coil spring may be provided between the substrate 140 and a bottom surface 110F of the casing 110.

The upper surface 140A of the substrate 140 is formed with four recessed portions 142, each having a circular shape, arranged in a cross shape. Each of the four recessed portions 142 has a shape recessed downward (in the negative Z-axis direction) from the upper surface 140A, has a predetermined depth in the vertical direction (in the Z-axis direction), and has a circular shape in a plan view seen from the upper direction (in the positive Z-axis direction). To the four recessed portions 142, each having a circular shape, the four second supports 213 included in the strain generator 210 of the force sensor 200 are correspondingly inserted from the upper direction (the positive Z-axis direction), and each of the four second supports 213 is screwed to be fixed from the lower direction (the negative Z-axis direction).

A push switch 141 is provided in the central portion of the lower surface 140B of the substrate 140 such that the press portion 141A faces downward. That is, the push switch 141 is provided such that the press portion 141A faces the bottom surface 110F of the recess 110D of the casing 110. A sum of the thickness of the substrate 140 and the thickness of the push switch 141 is substantially equal to the depth of the recess 110D of the lower casing 112. Therefore, the left and right ends of the upper surface of the substrate 140 contact the lower surface of the upper casing 111. The combined thickness of the touchpad unit 120 and the force sensor 200 is equal to the thickness of the upper casing 111, and the upper surface of the touchpad unit 120 and the upper surface of the upper casing 111 are on a same plane. The push switch 141 is configured to switch from an off state to an on state when the press portion 141A is pressed. When the touchpad unit 120 is pressed downward (in the negative Z-axis direction), the press portion 141A of the push switch 141 is pressed by the bottom surface 110F of the recess 110D of the casing 110, and thus, the touchpad unit 120 is switched to the on state. When the center of the touchpad unit 120 is pressed downward (in the negative Z-axis direction) or when the left and right edges of the touchpad unit 120 are simultaneously pressed downward (in the negative Z-axis direction), the touchpad unit 120 moves downward (in the negative Z-axis direction) while maintaining the parallel orientation, and the push switch 141 is switched to the on state. When one end of the touchpad unit 120 is pressed downward (in the negative Z-axis direction), the touchpad unit 120 is tilted together with the substrate 140, and then the push switch 141 is turned on. When the end of the touchpad unit 120 is pressed downward, the opposite end of the substrate 140 serves as a fulcrum and operates as a second lever. Thus, the push switch 141 can detect a pressing operation on the touchpad unit 120.

### Operation of Game Controller 100

In the game controller 100 according to one embodiment, when the touchpad unit 120 is tilted, the touchpad unit 120, the force sensor 200, and the substrate 140 are tilted together, and the push switch 141 is turned on. Then, when one end of the lower surface of the substrate 140 contacts the bottom surface 110F of the lower casing 112 and the other end of the upper surface of the substrate 140 contacts the lower surface of the upper casing 111, the substrate 140 is fixed to the casing 110 and does not move. Furthermore, when a downward force is applied to the end of the touchpad unit 120, a bending load is applied to the first support 212 of the strain generator 210 fixed to the touchpad unit 120, and the periphery of the first support 212 at the base 211 of the strain generator 210 is distorted. The game controller 100 according to one embodiment can detect the tilting operation (tilt direction and magnitude of the load) to the touchpad unit 120 by detecting the strain around the first support 212 at the base 211 of the strain generator 210 by four second strain sensors 233 provided at the base 211 of the strain generator 210. The second strain sensor 233 is an example of the strain resistor. When the push switch 141 is turned on, the reaction force fluctuates and a click feeling is obtained. Therefore, the operator can sense the lower limit of the tilting operation.

Additionally, in the game controller 100 according to one embodiment, when a pressing operation is performed on the touchpad unit 120, the touchpad unit 120 moves downward (in the negative Z-axis direction) while maintaining the horizontal state, and the push switch 141 is turned on. Furthermore, when a force is applied to the center of the touchpad unit 120 or a force is applied uniformly to both ends of the touchpad unit 120, a compressive load is applied to the first support 212 of the strain generator 210 fixed to the touchpad unit 120, and strain is generated around the central portion of the base 211 of the strain generator 210. The game controller 100 according to one embodiment can detect a pressing operation (magnitude of load) on the touchpad unit 120 by detecting strain around the central portion of the base 211 of the strain generator 210 by the four second strain sensors 233 provided on the base 211 of the strain generator 210.

Furthermore, in the game controller 100 according to one embodiment, when a rotational operation is performed on the touchpad unit 120, the touchpad unit 120 slightly rotates around the central axis. At this time, the base 211 of the strain generator 210 fixed to the touchpad unit 120 slightly rotates, and each of the four second supports 213 of the strain generator 210 tilts, and strain is generated around each of the four second supports 213. The game controller 100 according to one embodiment can detect a rotational operation (rotational direction and torsional load) on the touchpad unit 120 by detecting strain around each of the four second supports 213 in the base 211 of the strain generator 210 by eight first strain sensors 222 provided on the base 211 of the strain generator 210. The first strain sensors 222 are an example of the strain resistor. By adjusting a space between the touchpad unit 120 and the upper casing 111, it is possible to prevent an excessive torsional load from being applied to the strain generator 210.

In the force sensor 200, the eight first strain sensors 222 are provided around the first support 212 included in the strain generator 210. Each of the eight first strain sensors 222 is a resistor printed on the upper surface of the force sensor 200. The eight first strain sensors 222 are mainly provided to detect the rotational operation of the touchpad unit 120.

The force sensor 200 can output a strain detection signal (analog signal) representing the distortion of the base 211 detected by each of the eight first strain sensors 222 to the substrate 140 via a lead portion 220B.

A lead portion 230B is electrically connected to the substrate 140 at its distal end.

In the force sensor 200, four second strain sensors 233 are provided around a central projection 214 of the strain generator 210. Each of the four second strain sensors 233 is a resistor printed on the lower surface of the force sensor 200. The four second strain sensors 233 are mainly provided to detect the tilting operation (tilt direction and bending load) of the touchpad unit 120.

The force sensor 200 can output a strain detection signal (analog signal) representing the distortion of the base 211 detected by each of the four second strain sensors 233 to the substrate 140 through the lead portion 230B.

In the force sensor 200, on the upper surface of the base 211 of the strain generator 210, two first strain sensors 222 are provided in each of four directions (right (positive Y-axis direction), left (negative Y-axis direction), front (positive X-axis direction), and rear (negative X-axis direction)) with respect to the first support 212. In each direction, the two first strain sensors 222 are provided on a same circumference as a circumference passing through the four second supports 213 provided on the other side (negative Z-axis side) of the base 211, with a predetermined interval from each other. Thus, the eight first strain sensors 222 are provided around the first support 212 on the same circumference as the circumference passing through the four second supports 213. Furthermore, the eight first strain sensors 222 are provided at positions overlapping with outer edges of the second supports 213 provided on the other side (negative Z-axis side) of the base 211.

Each of the eight first strain sensors 222 is provided such that the circumferential direction is a detection direction. Thus, when the touchpad unit 120 is rotated, each of the eight first strain sensors 222 stretches or contracts in the circumferential direction, thereby changing its resistance value. Accordingly, the rotational operation can be detected.

Each of the eight first strain sensors 222 deforms (stretches or contracts) according to the distortion of the base 211 when the base 211 (around the four second supports 213) is distorted via the four second supports 213 due to the rotational operation of the touchpad unit 120, thereby changing the resistance value. Thus, each of the eight first strain sensors 222 can detect the distortion of the base 211 caused by the rotational operation of the touchpad unit 120, and thus can detect the rotational operation of the touchpad unit 120.

Here, in the force sensor 200 according to one embodiment, the eight first strain sensors 222 are provided in total of four directions (right (positive Y-axis direction), left (negative Y-axis direction), front (positive X-axis direction), and rear (negative X-axis direction)) so as to correspond to installation directions of the four second supports 213 around the first support 212. Thus, in the force sensor 200 according to one embodiment, when the rotational operation of the touchpad unit 120 is performed, the distortion of the base 211 in the four directions caused by the tilting of the four second supports 213 can be reliably detected by the first strain sensors 222 provided two per each direction, and thus the rotational operation can be detected with high sensitivity.

In the force sensor 200, one second strain sensor 233 is provided on the lower surface of the base 211 of the strain generator 210 in each of the four directions (right (positive Y-axis direction), left (negative Y-axis direction), front (positive X-axis direction), and rear (negative X-axis direction)), with respect to the central projection 214. That is, the four second strain sensors 233 are arranged in a cross shape around the central projection 214. In each direction, the second strain sensor 233 is provided between the central projection 214 and the second support 213. In particular, in all directions, the second strain sensor 233 is provided on the same circumference as a circumference formed by an outer edge of a root portion of the first support 212 provided on the other side (positive side of the Z-axis) of the base 211. Thus, the four second strain sensors 233 are provided around the central projection 214 inside the four second supports 213 and on the same circumference as the circumference formed by the outer edge of the root portion of the first support 212.

Each of the four second strain sensors 233 is provided in a direction such that the tilting direction of the first support 212 becomes the detection direction. Thus, when the touchpad unit 120 is tilted, each of the four second strain sensors 233 stretches or contracts in the tilting direction of the first support 212, thereby changing its resistance value. Accordingly, the tilting operation can be detected.

When the touchpad unit 120 is tilted and the base 211 (periphery of the root portion of the first support 212) is distorted via the first support 212, each of the four second strain sensors 233 changes its resistance value by being deformed (stretched or contracted) in accordance with the distortion of the base 211. Thus, each of the four second strain sensors 233 can detect the distortion of the base 211 caused by the tilting operation of the touchpad unit 120, and thus the tilting operation of the touchpad unit 120 can be detected.

Here, in the force sensor 200 according to one embodiment, the four second strain sensors 233 are provided in total of the four directions (right (positive Y-axis direction), left (negative Y-axis direction), front (positive X-axis direction), and rear (negative X-axis direction)) so as to correspond to directions of the tilting operation of the touchpad unit 120. Thus, even when the touchpad unit 120 is tilted in any of the four directions (right (positive Y-axis direction), left (negative Y-axis direction), front (positive X-axis direction), and rear (negative X-axis direction)), the force sensor 200 according to the embodiment can reliably detect the distortion of the base 211 caused through the first support 212 by the second strain sensor 233 provided in the operating direction, and can detect the tilting operation with high sensitivity.

The electrostatic sensor of the touchpad 122 used for detecting an operation position on the operation surface 120B is an example of the signal output part that outputs an output signal in accordance with the operation position where the operation is performed on the operation surface 120B. The eight first strain sensors 222 used for detecting the rotational operation are examples of the signal output part that output output signals in accordance with the magnitude and the direction of the torsional load applied to the touchpad unit 120 (operation part). The four second strain sensors 233 used for detecting the tilting operation and the pressing operation are examples of the signal output part that output output signals in accordance with the magnitude and direction of the bending load applied to the touchpad unit 120 (operation part).

### Configuration of Rotational-Operation Detecting Circuit 241

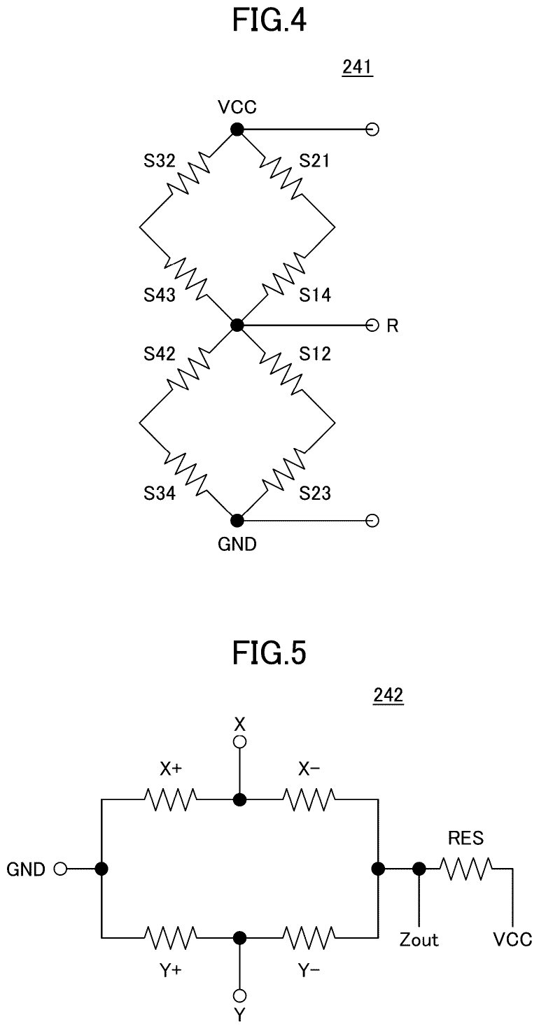

Next, the configuration of a rotational-operation detecting circuit 241 included in the force sensor 200 will be described with reference to FIG. 4. FIG. 4 is a circuit diagram of the rotational-operation detecting circuit 241 included in the force sensor 200 according to one embodiment.

In FIG. 4, resistors indicated as “S42” and “S43” mean the two first strain sensors 222 arranged on the positive side of the X-axis among the eight first strain sensors 222 included in the force sensor 200.

In FIG. 4, resistors indicated as “S21” and “S23” mean two first strain sensors 222 arranged on the negative side of the X-axis among the eight first strain sensors 222 included in the force sensor 200.

In FIG. 4, resistors indicated as “S32” and “S34” mean two first strain sensors 222 arranged on the positive side of the Y-axis among the eight first strain sensors 222 included in the force sensor 200.

In FIG. 4, resistors indicated as “S12” and “S14” mean two first strain sensors 222 arranged on the negative side of the Y-axis among the eight first strain sensors 222 included in the force sensor 200.

As illustrated in FIG. 4, the rotational-operation detecting circuit 241 included in the force sensor 200 includes two bridge circuits connected in series with each other, and each bridge circuit includes four first strain sensors 222.

One bridge circuit on a ground GND side includes four first strain sensors 222 (S42, S34, S12, and S23) arranged on a counterclockwise side with respect to the second supports 213 provided in the four directions, as viewed from above (positive Z-axis direction).

The other bridge circuit on a power supply voltage VCC side includes four first strain sensors 222 (S43, S32, S14, and S21) arranged on a clockwise side with respect to the second supports 213 provided in the four directions, as viewed from above (positive Z-axis direction).

For this reason, in the rotational-operation detecting circuit 241, when a counterclockwise rotational operation of the touchpad unit 120 is performed, resistance values of all four first strain sensors 222 (S42, S34, S12, and S23) provided on the counterclockwise side change toward a negative-value direction as the first strain sensors 222 contract, and resistance values of all four first strain sensors 222 (S43, S32, S14, and S21) provided on the clockwise side change in a positive-value direction as the first strain sensors 222 stretch. Thus, in the rotational-operation detecting circuit 241, when a ratio of a combined resistance of one bridge circuit to a combined resistance of the other bridge circuit changes, a divided output voltage R of the bridge circuits relatively changes. Therefore, the rotational-operation detecting circuit 241 can detect a counterclockwise rotational operation of the touchpad unit 120 based on a voltage value of the divided output voltage R.

Conversely, in the rotational-operation detecting circuit 241, when a clockwise rotational operation of the touchpad unit 120 is performed, the resistance values change in the positive-value direction as all four first strain sensors 222 (S42, S34, S12, and S23) provided on the counterclockwise side stretch, and the resistance values change in the negative-value direction as all four first strain sensors 222 (S43, S32, S14, and S21) provided on the clockwise side contract. Thus, in the rotational-operation detecting circuit 241, when the ratio of the combined resistance of one bridge circuit to the combined resistance of the other bridge circuit changes, the divided output voltage R between the bridge circuits changes. Therefore, the rotational-operation detecting circuit 241 can detect a clockwise rotational operation of the touchpad unit 120 based on a voltage value of the divided output voltage R.

### Configuration of Tilting-Operation Detecting Circuit 242

Next, the configuration of the tilting-operation detecting circuit 242 included in the force sensor 200 will be described with reference to FIG. 5. FIG. 5 is a circuit diagram of the tilting-operation detecting circuit 242 included in the force sensor 200 according to one embodiment.

In FIG. 5, a resistance marked “X+” means the second strain sensor 233 arranged on the positive X-axis side (hereinafter also referred to as “second strain sensor 233 (X+)”) among the four second strain sensors 233 included in the force sensor 200.

In FIG. 5, a resistance marked “X−” means the second strain sensor 233 arranged on a negative X-axis side (hereinafter also referred to as “second strain sensor 233 (X−)”) among the four second strain sensors 233 included in the force sensor 200.

In FIG. 5, a resistance marked “Y+” means the second strain sensor 233 arranged on the positive Y-axis side (hereinafter also referred to as “second strain sensor 233 (Y+)”) among the four second strain sensors 233 included in the force sensor 200.

In FIG. 5, a resistance indicated by “Y−” means the second strain sensor 233 arranged on the negative Y-axis side (hereinafter also referred to as “second strain sensor 233 (Y−)”) among the four second strain sensors 233 included in the force sensor 200.

As illustrated in FIG. 5, the tilting-operation detecting circuit 242 included in the force sensor 200 includes a bridge circuit configured by four second strain sensors 233.

Specifically, in the tilting-operation detecting circuit 242, the second strain sensor 233 (X+) and the second strain sensor 233 (X−) are connected in series. When the first support 212 is tilted in the X-axis direction, the resistance values of the two second strain sensors 233 change to values different in positive and negative signs from each other. Thus, in the tilting-operation detecting circuit 242, a ratio of the resistance values of the two second strain sensors 233 changes according to the tilt of the first support 212 in the X-axis direction, such that a voltage value of an intermediate point X between the two second strain sensors 233 changes. Therefore, the tilting-operation detecting circuit 242 can detect a tilt direction and a tilt angle in the X-axis direction of the touchpad unit 120 based on the voltage value of the intermediate point X. The tilting-operation detecting circuit 242 outputs a variable Lx as a negative value when the tilting direction in the X-axis direction is on the negative X-axis side, and outputs the variable Lx as a positive value when the tilting direction in the X-axis direction is on the positive X-axis side. The tilting-operation detecting circuit 242 outputs the tilt angle as an absolute value of the variable Lx. The magnitude of the tilt angle depends on the bending load applied to the first support 212. The tilting-operation detecting circuit 242 outputs the direction and the magnitude of the bending load as the negative or positive sign and the value of the variable Lx.

In the tilting-operation detecting circuit 242, the second strain sensor 233 (Y+) and the second strain sensor 233 (Y−) are connected in series. When the first support 212 is tilted in the Y-axis direction, the resistance values of the two second strain sensors 233 change to values different in positive and negative signs from each other. Thus, in the tilting-operation detecting circuit 242, a ratio of the resistance values of the two second strain sensors 233 changes in accordance with the tilt of the first support 212 in the Y-axis direction, such that a voltage value of an intermediate point Y between the two second strain sensors 233 changes. Therefore, the tilting-operation detecting circuit 242 can detect the tilt direction and the tilt angle in the Y-axis direction of the touchpad unit 120 based on the voltage value of the intermediate point Y. The tilting-operation detecting circuit 242 outputs a variable Ly as a negative value when the tilting direction in the Y-axis direction is on the negative Y-axis side, and outputs the variable Ly as a positive value when the tilting direction in the Y-axis direction is on the positive Y-axis side. The tilting-operation detecting circuit 242 outputs the tilt angle as an absolute value of the variable Ly. The magnitude of the tilt angle depends on the bending load applied to the first support 212. The tilting-operation detecting circuit 242 outputs the direction and the magnitude of the bending load as the negative or positive sign and the value of the variable Ly.

In the tilting-operation detecting circuit 242, a terminal Zout for detecting a divided voltage Zout is connected to a connection point between the second strain sensor 233 (X−) and the second strain sensor 233 (Y−), and a power supply voltage VCC is connected to a connection point between the second strain sensor 233 (X−) and the second strain sensor 233 (Y−) via a resistor RES.

The game controller 100 of the present embodiment can simultaneously perform the tilting operation of the touchpad unit 120 in the X-axis direction and the tilting operation of the touchpad unit 120 in the Y-axis direction. In this case, in the tilting-operation detecting circuit 242, the voltage value of the intermediate point X changes as the first support 212 tilts in the X-axis direction, and at the same time, the voltage value of the intermediate point Y changes as the first support 212 tilts in the Y-axis direction. Therefore, the tilting-operation detecting circuit 242 can detect both the tilting operation of the touchpad unit 120 in the X-axis direction (tilt direction and bending load) and the tilting operation of the touchpad unit 120 in the Y-axis direction (tilt direction and bending load) performed simultaneously based on the voltage value of the intermediate point X and the voltage value of the intermediate point Y.

In the tilting-operation detecting circuit 242, when the first support 212 is pressed downward (in the negative Z-axis direction), resistance values of the four second strain sensors 233 are uniformly changed. Thus, in the tilting-operation detecting circuit 242, the divided voltage Zout between the bridge circuit including the four second strain sensors 233 and a resistor (not illustrated) connected in series with the bridge circuit is changed according to an amount by which the first support 212 is pressed downward (in the negative Z-axis direction). Therefore, the tilting-operation detecting circuit 242 can detect the amount (compressive load) by which the touchpad unit 120 is pressed downward (in the negative Z-axis direction) based on a voltage value of the divided voltage Zout.

### Configuration of Game Machine 300 of the Embodiment

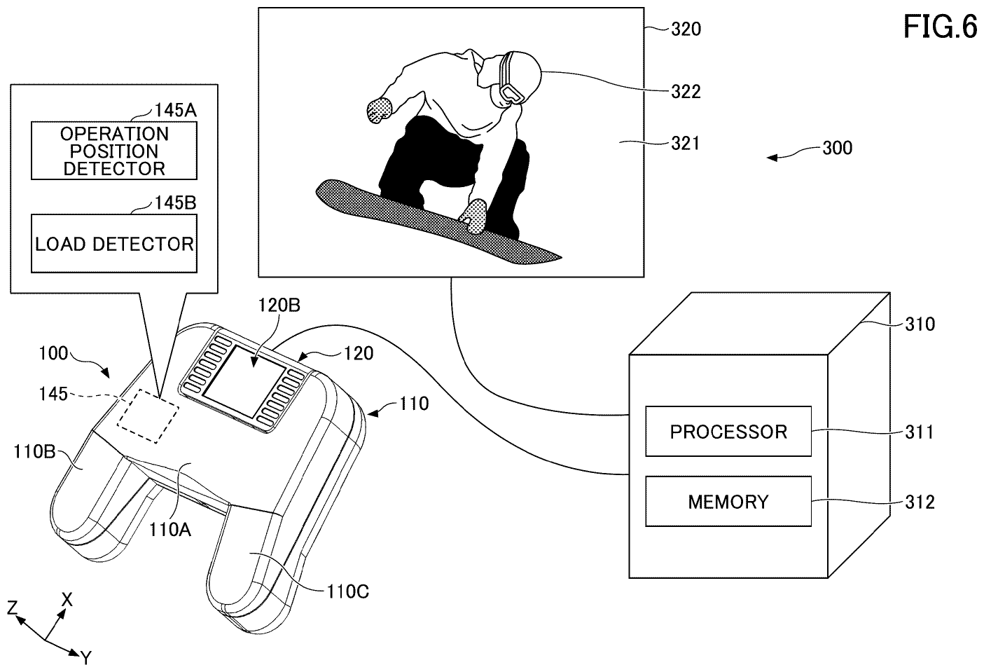

FIG. 6 is a diagram illustrating an example of a configuration of a game machine 300 of the embodiment. The game machine 300 includes a game controller 100, a game main body 310, and a display device 320. The configurations of the game main body 310 and the display device 320 will be described below.

As an example, the game controller 100 is connected to the game main body 310 via a cable, and the display device 320 is connected to the game main body 310 via a cable. However, at least one of the game controller 100 or the display device 320 may be connected to the game main body 310 by wireless communication.

The game controller 100 includes a controller 145. The controller 145 is mounted on the substrate 140, for example, and is implemented by a computer including, for example, a central processing unit (CPU), a random access memory (RAM), a read only memory (ROM), an input/output interface, and an internal bus.

The controller 145 includes an operation-position detector 145A and a load detector 145B. The operation-position detector 145A and the load detector 145B represent as a functional block, the function of the program executed by the controller 145.

### Operation-Position Detector 145A

The operation-position detector 145A detects an operation position in accordance with an output signal output from a signal output part (electrostatic sensor of the touchpad unit 120). The output signal output from the electrostatic sensor represents a count value obtained by digitally converting an electrostatic capacitance corresponding to the position where a fingertip or the like contacts the operation surface 120B. The operation-position detector 145A detects a position of a center of gravity of the fingertip or the like that contacts the operation surface 120B based on the count value representing the electrostatic capacitance. The operation-position detector 145A can detect a plurality of operation positions.

### Load Detector 145B

The load detector 145B detects the magnitude and direction of a load applied to the touchpad unit 120 in accordance with the output signal output from the signal output part (first strain sensor 222 and second strain sensor 233). The load detector 145B can detect the magnitude and the direction of a load for two directions (X direction and Y direction) parallel to the operation surface 120B and for a direction (Z direction) perpendicular to the operation surface 120B. Based on these loads, the load detector 145B can detect the loads of the pressing operation and the tilting operation.

The load detector 145B can also detect the magnitude and the direction (load vector) of the load in the clockwise direction and the magnitude and direction (load vector) of the load in the counterclockwise direction in a plan view of the operation surface 120B.

The load detector 145B detects an operation amount and a rotation direction of a rotational operation according to an output of the rotational-operation detecting circuit 241 including the eight first strain sensors 222. The load detector 145B detects a tilt direction and a tilt angle in the X-axis direction and/or the Y-axis direction and a downward (negative Z-axis direction) press amount due to the tilting operation according to an output of the tilting-operation detecting circuit 242 including the four second strain sensors 233.

Data representing the operation position detected by the operation-position detector 145A and the magnitude and direction of the load detected by the load detector 145B are transmitted to the game main body 310.

### Display Device 320

The display device 320 will be described before describing the game main body 310. The display device 320 is an example of a display of the game machine 300. The display device 320 may be a liquid crystal display, an organic light emitting diode (OLED), a projector, a screen, or the like, and may be any display device capable of displaying a moving image of a game.

The display device 320 displays an image based on an image signal supplied from the game main body 310. The image displayed on the display device 320 is displayed in a game space 321 as a virtual space. In FIG. 6, an image of a person riding a snowboard as an example is displayed as a player character 322 in the game space 321 displayed on the display device 320. The player character 322 is an example of an object arranged in the game space 321. The player character 322 can move on the ground in the game space 321. Non-player characters such as landforms and backgrounds are also displayed around the player character 322. A state in which the player character 322 is moving or stationary is an example of the state of an object.

In the following, description will be made based on a character representing a person riding a snowboard as the player character 322. However, the player character 322 may be a character representing a person riding a skateboard or a character representing a person playing a sport other than snowboarding or skateboarding. The player character 322 may be a character representing other than a person, such as an animal.

### Game Main Body 310

The game main body 310 includes a processor 311 and a memory 312. The memory 312 is an example of a storage. The memory 312 is an example of a recording medium in which a game program is stored. The game main body 310 is provided by a computer including a central processing unit (CPU), a random access memory (RAM), a read only memory (ROM), a hard disk drive (HDD), an input/output interface, an internal bus, and the like. An example of the recording medium in which a game program is stored is the RAM or the ROM provided as the memory 312, but the recording medium may be a medium other than the RAM or the ROM.

The processor 311 represents a function of the program executed by the game main body 310 as a functional block. The memory 312 functionally represents the memory of the game main body 310.

### Processor 311

The processor 311 refers to the control data stored in the memory 312 and calculates a next state of the player character 322 according to the operation position detected by the operation-position detector 145A, the magnitude and the direction of the load detected by the load detector 145B, and a state of the player character 322. The magnitude and the direction of the load represent a load vector.

The processor 311 outputs an image signal representing the next state of the player character 322 to the display device 320. When the processor 311 executes this processing, an image of each frame of a moving image displayed on the display device 320 is generated, and when the processor 311 repeatedly executes this processing, a moving image is displayed on the display device 320.

The processor 311 calculates a state of the player character 322 based on an amount of change in the magnitude of the load detected by the load detector 145B. This corresponds, for example, to a case where the player character 322 applies a force in the vertical direction without moving forward, backward, left, or right.

The processor 311 may control a jumping motion of the player character 322 based on the operation position detected by the operation-position detector 145A and the amount of change in the magnitude and the direction of the load detected by the load detector 145B.

The processor 311 may control, in a floating state after the jumping motion of the player character 322 is performed, the jumping motion of the player character 322 based on the operation position detected by the operation-position detector 145A and the amount of change in the magnitude and the direction of the load detected by the load detector 145B.

When the player character 322 lands, the processor 311 may control the landing action of the player character 322 according to the state of the player character 322, the operation position detected by the operation-position detector 145A, and the amount of change in the magnitude and the direction of the load detected by the load detector 145B. The landing action can be roughly divided into two types, successful landing and unsuccessful landing, and may include various patterns of landing actions, such as a state in which the player character successfully landed without a disturbed posture, a state in which the player character managed to land although with a disturbed posture, a state in which the player character failed to land and with posture being slightly disturbed, or a state in which the player character failed to land and with a large fall, according to the state of the player character 322, the operation position, or the amount of change in the load vector.

### Memory 312

The memory 312 stores control data that associates operation contents by the operator with the state of the player character 322. In addition to the control data, the memory 312 stores programs, data, and the like necessary for the control processing, which are required to cause the processor 311 to operate the game machine 300.

### One Example of Processing Contents of Processor 311

Hereinafter, processing contents of the processor 311 will be described. A case will be described in which the player character 322 on a skateboard is operated by operating the operation surface 120B with two fingertips.

As an example, the player character 322 on a skateboard has the left foot positioned on a front side in a traveling direction and the right foot positioned on a rear side in the traveling direction, and a negative Y-axis direction side of the operation surface 120B corresponds to the front side in the traveling direction and a positive Y-axis direction side corresponds to the rear side in the traveling direction. Therefore, in the Y direction of the operation surface 120B, the front foot is operated by the fingertip on the negative Y-axis direction side and the rear foot is operated by the fingertip on the positive Y-axis direction side. It is to be noted that which foot is to be placed in front and which of the negative Y-axis direction side or the positive Y-axis direction side of the operation surface 120B is to be placed in front may be selectable by setting.

### Vertical Posture Control of Player Character 322

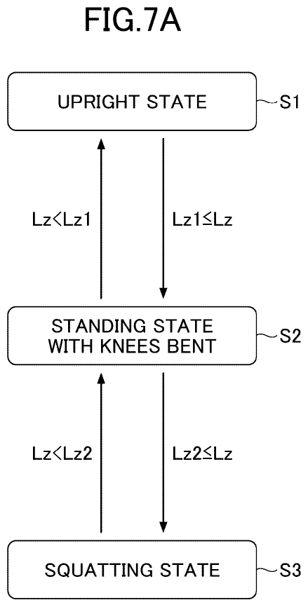

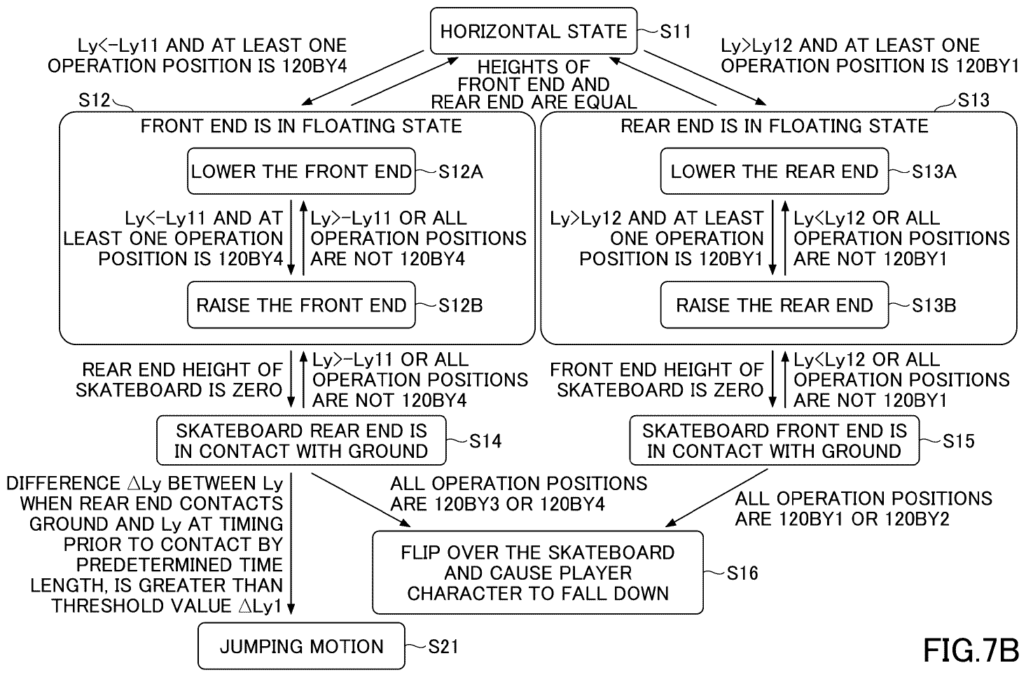

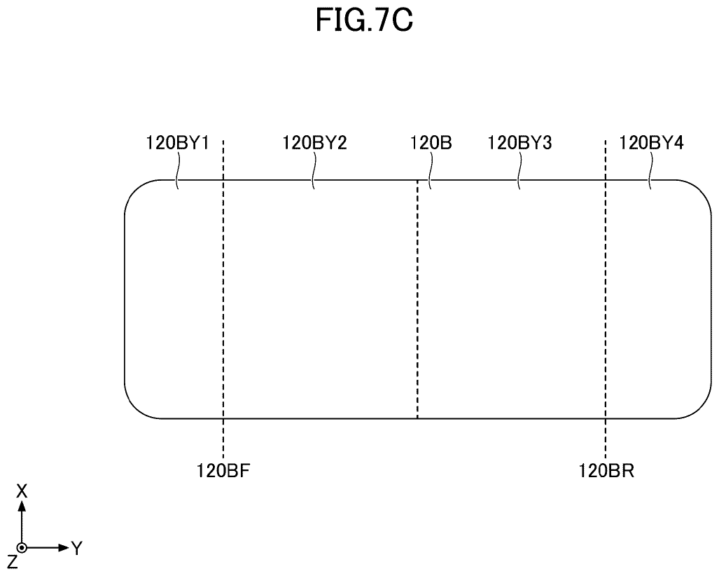

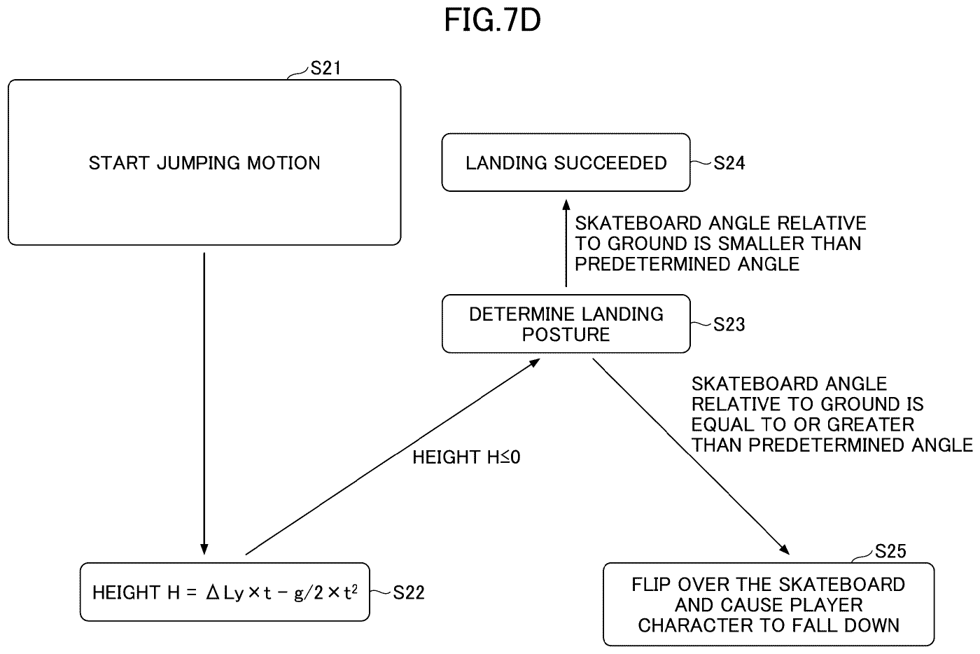

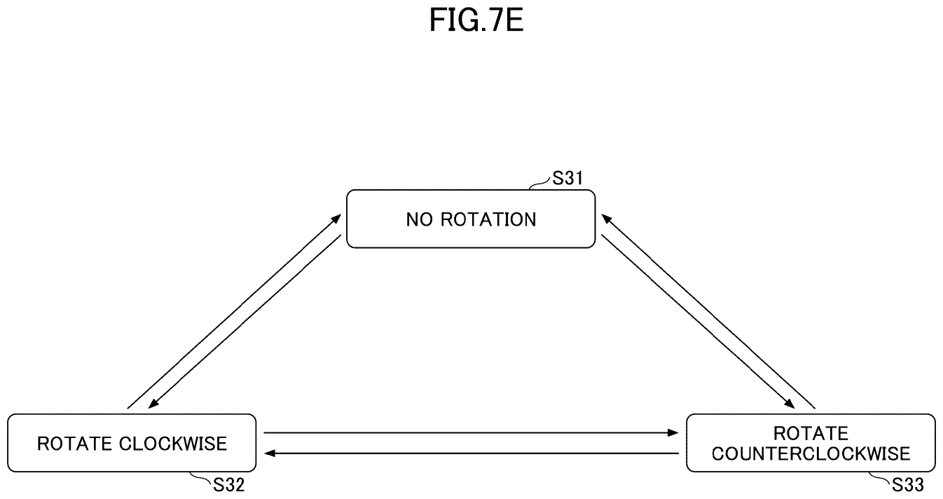

FIG. 7A is a diagram illustrating an example of state transitions when operating the vertical posture of the player character 322. The vertical posture of the player character 322 can be operated into three states: an upright state (S1), a standing state (S2) with knees bent, and a squatting state (S3) depending on the magnitude of the load of the pressing operation for pressing the touchpad unit 120 in the negative Z-axis direction. As an example, the vertical posture of the player character 322 is based on the upright state (S1).

The processor 311 holds the player character 322 in the upright state (S1) when the vertical posture of the player character 322 is in the upright state (S1) and a load Lz of the pressing operation detected by the load detector 145B is smaller than a threshold value Lz1. When the load Lz is equal to or greater than the threshold value Lz1, the posture of the player character 322 is changed to the standing state with the knees bent (S2).

The processor 311 holds the player character 322 in the standing state with the knees bent (S2) when the posture of the player character 322 is in the standing state with the knees bent (S2) and the load Lz of the pressing operation detected by the load detector 145B is equal to or greater than the threshold value Lz1 and smaller than a threshold value Lz2 (>Lz1). The threshold value Lz2 is greater than the threshold value Lz1.

When the load Lz of the pressing operation detected by the load detector 145B becomes equal to or greater than the threshold value Lz2 when the player character 322 is standing with the knees bent (S2) in the vertical direction, the processor 311 changes the posture of the player character 322 to the squatting state (S3).

When the load Lz of the pressing operation detected by the load detector 145B becomes smaller than the threshold value Lz1 when the player character 322 is standing with the knees bent (S2) in the vertical direction, the processor 311 changes the posture of the player character 322 to the upright state (S1).

When the load Lz of the pressing operation detected by the load detector 145B becomes smaller than the threshold value Lz2 when the player character 322 is in the squatting state (S3), the processor 311 changes the posture of the player character 322 to the standing state with the knees bent (S2).

### Posture Control of Player Character 322 in Skateboard Longitudinal Direction

FIG. 7B is a diagram illustrating an example of state transitions when the skateboard longitudinal posture of the player character 322 is manipulated.

As an example, the longitudinal posture of the skateboard is horizontal when no operation is performed on the touchpad unit 120 (S11). Horizontal means that both front wheels and rear wheels of the skateboard are on the ground and the height of a portion of the skateboard to which the front wheels are attached is equal to the height of a portion to which the rear wheels are attached.

In the horizontal state (S11), the processor 311 raises the front end of the skateboard (S12) when the bending load Ly in the longitudinal direction by the tilting operation is smaller than a threshold value −Ly11 and at least one operation position is in the range 120BY4 behind the axle (120BR) of the rear wheels of the skateboard. To raise the front end of the skateboard means to set the front end of the skateboard in a floating state (S12). Note that the negative or positive sign of the bending load Ly in the longitudinal direction indicates the Y direction of the bending load. The threshold value −Ly11 is a negative value. The threshold value −Ly11 is a threshold value used when the positive Y-axis side of the operation surface 120B (right-side portion of the operation surface 120B as illustrated in FIG. 7C) is pressed.

In the floating state (S12), the processor 311 raises the front end of the skateboard when the bending load Ly in the longitudinal direction by the tilting operation is smaller than the threshold value −Ly11 and at least one operation position is in a range (120BY4) behind an axle (120BR) of the rear wheels of the skateboard (S12B). Additionally, the processor 311 lowers the front end of the skateboard when the bending load Ly in the longitudinal direction by the tilting operation is greater than the threshold value −Ly11 or all the operation positions are in a front range (120BY1, 120BY2, or 120BY3) of the axle (120BR) of the rear wheels of the skateboard (S12A). When the heights of the front and rear ends of the skateboard become equal, the skateboard returns to the horizontal state (S11).

When the height of the rear end of the skateboard becomes zero in the state where the front end of the skateboard is floating (S12), the processor 311 brings the rear end of the skateboard into contact with the ground (S14).

When the rear end of the skateboard is in contact with the ground (S14) and all operation positions are behind the center of the skateboard in the longitudinal direction (120BY3 or 120BY4), the processor 311 flips the skateboard over and causes the player character 322 to fall down (S16).

In the horizontal state (S11), the processor 311 raises the rear end of the skateboard when the bending load Ly in the longitudinal direction becomes greater than the threshold value Ly12 by the tilting operation and at least one operation position is in the range 120BY1 in front of the axle (120BF) of the front wheels of the skateboard (S13). The threshold value Ly12 is a positive value. The threshold value Ly12 is a threshold value used when the negative Y-axis side of the operation surface 120B (left-side portion of the operation surface 120B as illustrated in FIG. 7C) is pressed.

When the rear end of the skateboard is in the floating state (S13), the processor 311 raises the rear end of the skateboard when the load Ly in the longitudinal direction becomes greater than the threshold value Ly12 and at least one operation position is in the front range (120BY1) of the axle (120BF) of the front wheels of the skateboard (S13B). Additionally, the processor 311 lowers the rear end of the skateboard when the load Ly in the longitudinal direction is smaller than the threshold value Ly12 or all operation positions are in a range (120BY2, 120BY3, or 120BY4) behind the axle (120BF) of the front wheels of the skateboard (S13A). When the heights of the front and rear ends of the skateboard become equal, the skateboard returns to the horizontal state (S11).

When the height of the front end of the skateboard becomes zero in the state where the rear end of the skateboard is floating (S13), the processor 311 brings the front end of the skateboard into contact with the ground (S15).

When a difference ΔLy between the load Ly when the rear end of the skateboard is in contact with the ground and the load Ly at timing prior to the contact by a predetermined time period is greater than a jump threshold value ΔLy1 in the state where the rear end of the skateboard is in contact with the ground (S14), the processor 311 starts a jump operation (S21). A state after the start of the jump operation will be described in the following.

When the rear end of the skateboard is in contact with the ground (S14) and all operation positions are behind the center of the skateboard in the longitudinal direction (120BY3 or 120BY4), the processor 311 turns the skateboard over and causes the player character 322 to fall down (S16).

When the front end of the skateboard is in contact with the ground (S15) and all operation positions are in front of the center of the skateboard in the longitudinal direction (120BY1 or 120BY2), the processor 311 turns the skateboard over and causes the player character 322 to fall down (S16).

### Four Predetermined Longitudinal Ranges of Skateboard

FIG. 7C is a diagram illustrating an example of four operation positions on the operation surface 120B for operating the skateboard tilting. The position 120BF in the Y direction is a position where the axle of the front wheels of the skateboard is located, and the position 120BR in the Y direction is a position where the axle of the rear wheels of the skateboard is located. FIG. 7C is a diagram illustrating the range 120BY1 in front of the position where the front axle 120BF is located, the range 120BY2 in rear of the front axle 120BF and in front of the center, the range 120BY3 in rear of the center and in front of the rear axle 120BR, and the range 120BY4 in rear of the rear axle 120BR.

### Control of Jumping Motion

FIG. 7D is a diagram illustrating an example of control of a jumping motion.

The processor 311 performs control such that the player character 322 performs a jumping motion, when the difference ΔLy between Ly when the rear end contacts the ground and Ly at timing prior to the contact by a predetermined time period is greater than the jump threshold value ΔLy1.

The processor 311 calculates a height H of the player character by using the difference ΔLy between the Ly when the rear end contacts the ground and the Ly at timing before the contact by the predetermined time period, a time t that is a length of time elapsed from the start of the jumping motion, and a constant value (e.g., a gravitational acceleration g) (S22). The height H is calculated by H=ΔLY×t−g/2×t² as an example. When the height H becomes zero or less, the skateboard lands.

When the height H becomes zero or less, the processor 311 determines the posture of the player character 322 (S23).

When the landing posture of the player character 322 is good, the processor 311 determines that the landing is successful (S24). Good landing posture means, as an example, that an angle of the skateboard relative to the ground is less than a predetermined angle.

When the landing posture of the player character 322 is unfavorable, the processor 311 determines that the landing is unsuccessful and flips the skateboard over and causes the player character 322 to fall down (S25). An unfavorable landing posture means, as an example, that the angle of the skateboard relative to the ground is a predetermined angle or greater.

### Posture Control of Player Character 322 by Rotational Operation

FIG. 7E is a diagram illustrating an example of posture control of the player character 322 by a rotational operation. The processor 311 does not rotate the player character 322 when the rotational operation is not performed (S31).

When a clockwise rotational operation is performed, the processor 311 rotates the player character 322 clockwise (S32). Clockwise means in a clockwise direction when viewed from the positive Z-axis direction.

When a counterclockwise rotational operation is performed, the processor 311 rotates the player character 322 counterclockwise (S33). Counterclockwise means in a counterclockwise direction when viewed from the positive Z-axis direction.

### Specific Example 1 of Player Character 322 Motion

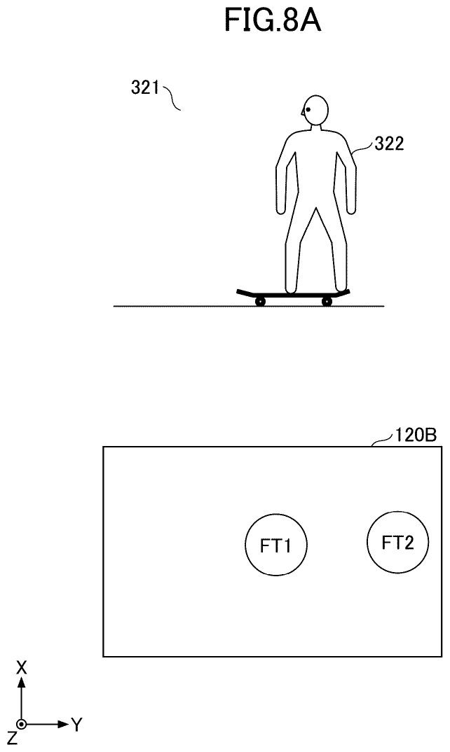

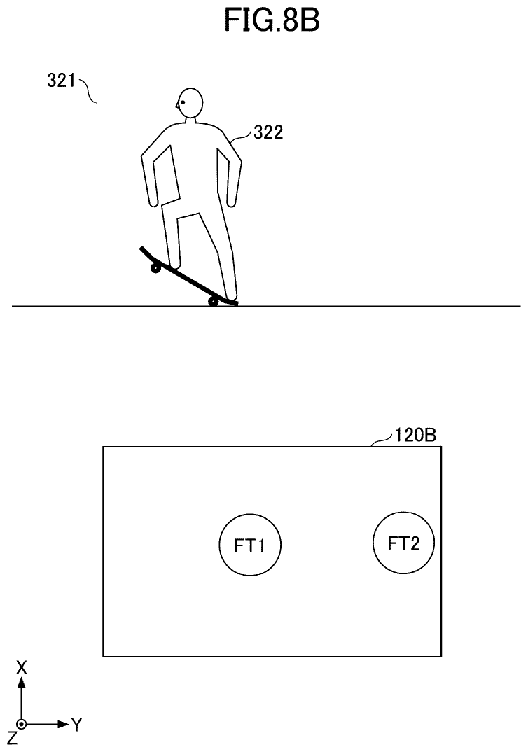

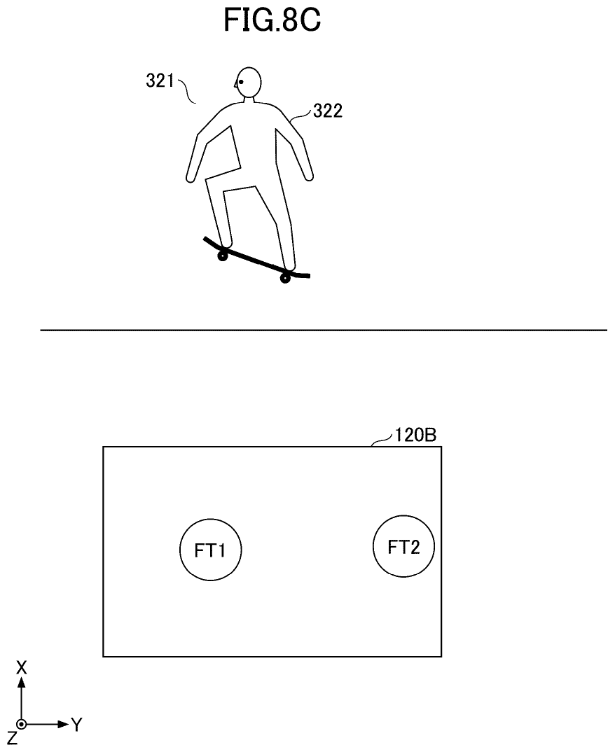

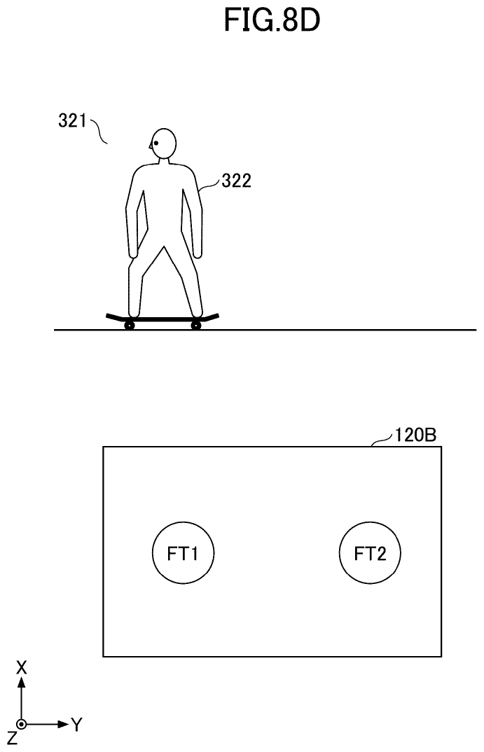

FIGS. 8A to 8D are diagrams illustrating a specific example 1 of a player character 322 motion. In FIGS. 8A to 8D, an example of the state of player character 322 in the game space 321 is illustrated on an upper side, and an example of the positions of two fingertips FT1 and FT2 on the operation surface 120B is illustrated on a lower side. Here, an example of a mode of operating the player character 322 by using two fingertips FT1 and FT2 will be described. As an example, a case in which the player character 322 performs skateboarding will be described.

Furthermore, as an example, it is assumed that the left foot is positioned on the front side in the traveling direction and the right foot is positioned on the rear side in the traveling direction. The negative Y-axis direction side of the operation surface 120B is determined to be the front side in the traveling direction and the positive Y-axis direction side is determined to be positioned on the rear side in the traveling direction. Therefore, the fingertip FT1 corresponds to the front foot and the fingertip FT2 corresponds to the rear foot.

In FIG. 8A, the player character 322 gently bends both knees by gently pressing the fingertips FT1 and FT2 downward. The fingertip FT1 is positioned substantially in the center of the operation surface 120B in the X direction and the Y direction, and the fingertip FT2 is positioned substantially in the center of the operation surface 120B in the X direction and on the rear side in the Y direction. The skateboard is horizontal.

In FIG. 8B, the fingertip FT2 corresponding to the rear foot strongly presses the end of the operation surface 120B in the positive Y-axis direction, and the rear foot of the player character 322 kicks the rear end of a tail of the skateboard downward, and the rear end of the skateboard kicks the ground, such that the front end of the skateboard and the front foot rise upward. In this state, the player character 322 jumps.

In FIG. 8C, by weakening the downward pressure of the fingertip FT2 corresponding to the rear foot, the rear foot of the player character 322 rises relatively to the front foot. When the operation positions of the fingertips FT1 and FT2 are slightly moved forward within the two predetermined ranges 120BY2 and 120BY3 as illustrated in FIG. 7C, the angle of the skateboard approaches to the horizontal. In this state, the player character 322 is in a jumping state with respect to the ground.

In FIG. 8D, the knees of the player character are gently bent because the force for pressing the operation surface 120B downward is weakened, such that the player character 322 can absorb the impact upon landing after the jump. Then, the player character 322 lands on the ground. Since the angle of the skateboard relative to the ground is less than the predetermined angle, the landing is successful.

### Specific Example 2 of Player Character 322 Motion

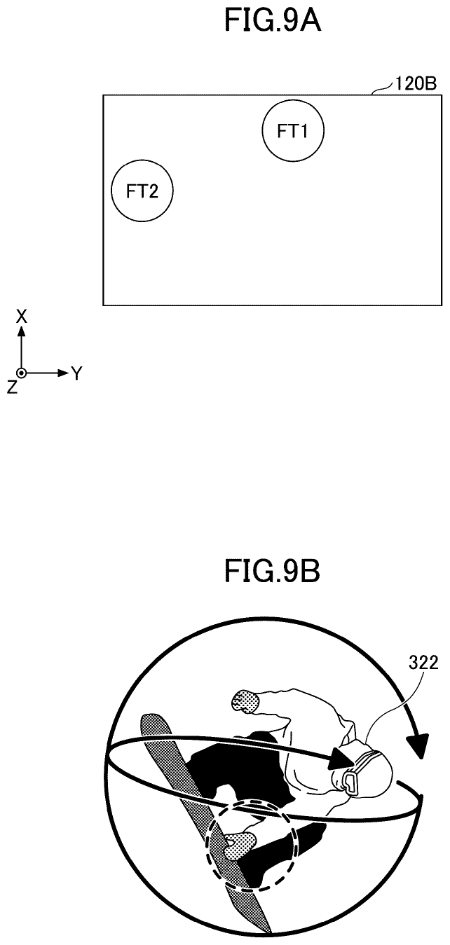

FIGS. 9A and 9B are views for explaining a specific example 2 of the motion of the player character 322.

FIG. 9A is a diagram illustrating the operation positions of the fingertips FT1 and FT2 on the operation surface 120B. FIGS. 9A and 9B are diagrams illustrating a game simulating snowboarding. In the actual snowboarding, the positions where the feet are placed are determined. However, in a present embodiment, the positions of the fingertips FT1 and FT2 may be at any places other than the edges of the operation surface 120B, that is any positions where the direction and the strength of the load can be easily controlled by touching.

When the fingertip FT1 is positioned on the positive Y-axis side of the center of the operation surface 120B in the Y direction, and the fingertip FT2 is positioned on the negative Y-axis side of the operation surface 120B, and a counterclockwise rotational operation is performed by increasing the downward pressing force of the fingertip FT2, a coke, which is one of the techniques of snowboarding, can be performed. At this time, when the fingertips FT1 and FT2 touch the edges of the operation surface, an edge of the snowboard can be gripped.

### Effect

The game machine 300 includes the touchpad unit 120 including the operation surface 120B which is operated by an operator, the signal output part (the electrostatic sensor, the first strain sensors 222, and the second strain sensors 233) configured to output a plurality of output signals in accordance with the operation position where the operation is performed on the operation surface 120B and the magnitude and the direction of the load applied to the touchpad unit 120, an operation-position detector 145A configured to detect the operation position on the basis of one or more of the output signals output from the signal output part, the load detector 145B configured to detect the magnitude and direction of the load applied to the touchpad unit 120 on the basis of one or more of the output signals output from the signal output part, the processor 311 configured to calculate the state of the player character 322 arranged in a game space, and the memory 312 configured to store control data associating the operation contents of the operator with a current state of the player character 322. The processor 311 calculates a next state of the player character 322 by referencing the control data according to the operation position detected by the operation-position detector 145A, the magnitude and direction of the load detected by the load detector 145B, and the current state of the player character 322. Accordingly, the object can be operated according to the operation position on the operation surface 120B and the magnitude and direction of the load applied to the touchpad unit 120.

Therefore, the game machine 300, which provides various input means for operating the motion of the object and can achieve a game rich in variations can be provided.

Furthermore, the processor 311 may calculate the state of the object based on an amount of change in the magnitude of the load detected by the load detector 145B. Therefore, the object can be operated according to the amount of change in the magnitude of the load applied to the touchpad unit 120.

Furthermore, the processor 311 may calculate a state of the object based on the amount of change in the magnitude and the direction of the load detected by the load detector 145B. The magnitude and direction of the load represent a load vector. Therefore, the object can be operated according to the amount of change in the magnitude (load vector) of the load applied to the touchpad unit 120.

Furthermore, the operation-position detector 145A may be configured to detect a plurality of operation positions. Therefore, for example, a plurality of parts such as both feet of the object, and a foot and a hand can be operated, and the game machine 300, which provides various input means for operating the motion of the object and can achieve a game rich in variations can be provided.

Furthermore, the load detector 145B may be configured to detect the magnitude and the direction of the load in the direction in which the operation surface 120B is tilted and in the direction perpendicular to the operation surface 120B. The operation of the object can be operated in three directions, two directions parallel to the operation surface 120B and a direction perpendicular to the operation surface 120B, and thus the game machine 300 can be operated more intuitively.

The load detector 145B may be configured to detect the magnitude and the direction of the load in the clockwise direction, and the magnitude and the direction of the load in the counterclockwise direction in a plan view of the operation surface 120B. The operation of rotating the object can be performed according to the direction of the load applied to the touchpad unit 120, and thus the game machine 300, which provides various input means for operating the motion of the object and can achieve a game rich in variations can be provided.

The object is the player character 322 that can move on the ground in the game space 321, and the processor 311 may control the jumping motion of the player character 322 based on the operation position detected by the operation-position detector 145A and the amount of change in the magnitude and direction of the load detected by the load detector 145B. The jumping motion of the player character 322 can be finely operated in accordance with the operation position on the operation surface 120B and the magnitude and the direction of the load applied to the touchpad unit 120. For this reason, the game machine 300, which provides various input means for operating the jumping motion of the player character 322 and can achieve a game rich in variations can be provided.

Furthermore, in a floating state after the jumping motion of the player character is performed, the processor 311 may control a floating motion of the player character 322 based on the operation position detected by the operation-position detector 145A and the amount of change in the magnitude and the direction of the load detected by the load detector 145B. The floating state after the jumping motion of the player character 322 can be finely operated in accordance with the operation position on the operation surface 120B and the magnitude and the direction of the load applied to the touchpad unit 120. For this reason, the game machine 300, which provides various input means for operating the floating state of the player character 322 after the jumping motion and can achieve a game rich in variations can be provided.

When the player character 322 lands, the processor 311 may control a landing action of the player character 322 in accordance with the state of the player character 322, the operation position detected by the operation-position detector 145A, and the amount of change in the magnitude and the direction of the load detected by the load detector 145B. The landing action of the player character 322 can be finely operated in accordance with the operation position on the operation surface 120B and the magnitude and the direction of the load applied to the touchpad unit 120. For this reason, the game machine 300, which provides various input means for operating the landing action of the player character 322 and can achieve a game rich in variations can be provided.

The player character 322 may be a character of a person performing skateboarding or snowboarding. The motion of the player character 322 performing skateboarding or snowboarding can be finely manipulated in accordance with the operation position on the operation surface 120B and the magnitude and the direction of the load applied to the touchpad unit 120. For this reason, the game machine 300, which provides various input means for operating the player character 322 performing skateboarding or snowboarding and can achieve a game rich in variations can be provided.

The signal output part may also include an electrostatic sensor configured to output a signal in accordance with the operation position on the touchpad unit 120, and a first strain sensor 222 and a second strain sensor 233 (strain resistor) configured to output signals in accordance with the magnitude and direction of the load applied to the touchpad unit 120. The object can be precisely manipulated in accordance with the operation position on the operation surface 120B detected based on outputs of the electrostatic sensor and the strain resistor, and the magnitude and the direction of the load applied to the touchpad unit 120.

With respect to the game-machine program used in the game machine 300, the game-machine program includes: the touchpad unit 120 that includes the operation surface 120B to be operated by an operator; the signal output part (electrostatic sensor, first strain sensors 222, and second strain sensors 233) configured to output an output signal in accordance with an operation position to be operated on the operation surface 120B and the magnitude and the direction of a load applied to the touchpad unit 120; the operation-position detector 145A configured to detect an operation position in accordance with one or more of output signals output from the signal output part, and the load detector 145B configured to detect the magnitude and the direction of the load applied to the touchpad unit 120 based on one or more of the output signals output from the signal output part. A computer connected to the signal output part functions as a processor 311 for calculating a state of the player character 322 arranged in a game space, and the processor 311 calculates a next state of the player character 322 in accordance with the operation position detected by the operation-position detector 145A, the magnitude and the direction of the load detected by the load detector 145B, and the state of the player character 322 by referring to control data associating the operation contents of the operator with the state of the player character 322. Therefore, the object can be operated according to the operation position on the operation surface 120B and the magnitude and the direction of the load applied to the touchpad unit 120.

Accordingly, a game-machine program which provides various input means for operating the motion of the object and can achieve a game rich in variations can be provided.

A game machine, which provides various input means for operating the motion of the object and can achieve a game rich in variations, a game-machine program, and a recording medium storing the game-machine program, can be provided.

The game machine, the game-machine program, and the recording medium storing the game-machine program according to the exemplary embodiment of the present disclosure have been described above, but the present disclosure is not limited to the embodiment specifically disclosed, and various modifications and changes can be made without departing from the scope of the claims.

With respect to the above embodiment, the following clauses are further disclosed.

### (Clause 1)

A game machine, comprising:
an operation part that includes an operation surface on which an operation is performed by an operator;
a signal output part configured to output an output signal in accordance with an operation position to which an operation is performed on the operation surface, and a magnitude and a direction of a load applied to the operation part;
an operation-position detector configured to detect the operation position in accordance with one or more of the output signals output from the signal output part;
a load detector configured to detect the magnitude and the direction of the load applied to the operation part in accordance with the output signal output from the signal output part;
a processor configured to calculate a state of an object arranged in a game space; and
a storage configured to store control data associating operation contents by the operator with the state of the object, wherein
the processor calculates the state of the object by referencing the control data, in accordance with the operation position detected by the operation-position detector, the magnitude and the direction of the load detected by the load detector, and a current state of the object.

### (Clause 2)

The game machine according to clause 1, wherein
the processor calculates the state of the object based on an amount of change in the magnitude of the load detected by the load detector.

### (Clause 3)

The game machine according to clause 1, wherein
the processor calculates the state of the object based on an amount of change in the magnitude and an amount of change in the direction of the load detected by the load detector.

### (Clause 4)

The game machine according to clause 3, wherein
the operation-position detector is capable of detecting a plurality of operation positions, each being the operation position.

### (Clause 5)

The game machine according to clause 4, wherein
the load detector is capable of detecting the magnitude and the direction of the load for a direction in which the operation surface is tilted and a direction perpendicular to the operation surface.

### (Clause 6)

The game machine according to clause 5, wherein
the load detector is capable of detecting the magnitude and the direction of the load in a clockwise direction and the magnitude and the direction of the load in a counterclockwise direction in a plan view of the operation surface.

### (Clause 7)

The game machine according to any one of clauses 3 to 6, wherein
the object is a player character movable on a ground in the game space, and
the processor is configured to control a jumping motion of the player character based on the operation position detected by the operation-position detector and the amount of change in the magnitude and the direction of the load detected by the load detector.

### (Clause 8)

The game machine according to clause 7, wherein
the processor controls, in a floating state after the jumping motion of the player character is performed, the jumping motion of the player character based on the operation position detected by the operation-position detector and the amount of change in the magnitude and the direction of the load detected by the load detector.

### (Clause 9)

The game machine according to clause 7, wherein
the processor controls a landing action of the player character according to a state of the player character, the operation position detected by the operation-position detector, and the amount of change in the magnitude and the direction of the load detected by the load detector, upon landing of the player character.

### (Clause 10)

The game machine according to clause 9, wherein
the player character is a character of a person performing skateboarding or snowboarding.

### (Clause 11)

The game machine according to any one of clauses 1 to 10, wherein
the signal output part includes,
an electrostatic sensor configured to output a signal in accordance with the operation position of the operation to the operation part; and
a strain resistor configured to output a signal in accordance with the magnitude and the direction of the load applied to the operation part.

### (Clause 12)

A game-machine program, comprising:
an operation part that includes an operation surface on which an operation is performed by an operator;
a signal output part configured to output an output signal in accordance with an operation position to which an operation is performed on the operation surface, and magnitude and a direction of a load applied to the operation part;
an operation-position detector configured to detect the operation position in accordance with one or more of the output signals output from the signal output part;
a load detector configured to detect the magnitude and the direction of the load applied to the operation part in accordance with the output signal output from the signal output part; wherein
a computer connected to the signal output part is caused to function as a processor for calculating a state of an object arranged in a game space, and
the processor calculates a next state of the object in accordance with the operation position detected by the operation-position detector, the magnitude and the direction of the load detected by the load detector, and the state of the object by referring to control data associating operation contents of the operator with the next state of the object.

### (Clause 13)

A recording medium storing a game-machine program, comprising:
an operation part that includes an operation surface on which an operation is performed by an operator;
a signal output part configured to output an output signal in accordance with an operation position to which an operation is performed on the operation surface, and a magnitude and a direction of a load applied to the operation part;
an operation-position detector configured to detect the operation position in accordance with one or more of the output signals output from the signal output part; and
a load detector configured to detect the magnitude and the direction of the load applied to the operation part in accordance with one or more of the output signals output from the signal output part; wherein
a computer connected to the signal output part functions as a processor configured to calculate a state of an object arranged in a game space, and
the processor is configured to calculate a next state of the object in accordance with the operation position detected by the operation-position detector, the magnitude and the direction of the load detected by the load detector, and the state of the object by referring to control data associating operation contents of the operator with the state of the object.

What is claimed is:

1. A game machine, comprising:
an operation part that includes an operation surface on which an operation is performed by an operator;
a signal output part configured to output an output signal in accordance with an operation position to which an operation is performed on the operation surface, and a magnitude and a direction of a load applied to the operation part;
an operation-position detector configured to detect the operation position in accordance with one or more of output signals, each being the output signal, output from the signal output part;
a load detector configured to detect the magnitude and the direction of the load applied to the operation part in accordance with one or more of the output signals output from the signal output part;
a processor configured to calculate a state of an object arranged in a game space; and
a storage configured to store control data associating operation contents by the operator with the state of the object, wherein
the processor calculates the state of the object by referencing the control data, in accordance with the operation position detected by the operation-position detector, the magnitude and the direction of the load detected by the load detector, and a current state of the object.

2. The game machine according to claim 1, wherein
the processor calculates the state of the object based on an amount of change in the magnitude of the load detected by the load detector.

3. The game machine according to claim 1, wherein
the processor calculates the state of the object based on an amount of change in the magnitude and an amount of change in the direction of the load detected by the load detector.

4. The game machine according to claim 3, wherein
the operation-position detector is capable of detecting a plurality of operation positions, each being the operation position.

5. The game machine according to claim 4, wherein
the load detector is capable of detecting the magnitude and the direction of the load for a direction in which the operation surface is tilted and a direction perpendicular to the operation surface.

6. The game machine according to claim 5, wherein
the load detector is capable of detecting the magnitude and the direction of the load in a clockwise direction and the magnitude and the direction of the load in a counterclockwise direction in a plan view of the operation surface.

7. The game machine according to claim 3, wherein
the object is a player character movable on a ground in the game space, and
the processor is configured to control a jumping motion of the player character based on the operation position detected by the operation-position detector and the amount of change in the magnitude and the direction of the load detected by the load detector.

8. The game machine according to claim 7, wherein
the processor controls, in a floating state after the jumping motion of the player character is performed, the jumping motion of the player character based on the operation position detected by the operation-position detector and the amount of change in the magnitude and the direction of the load detected by the load detector.

9. The game machine according to claim 7, wherein
the processor controls a landing action of the player character according to a state of the player character, the operation position detected by the operation-position detector, and the amount of change in the magnitude and the direction of the load detected by the load detector, upon landing of the player character.

10. The game machine according to claim 9, wherein
the player character is a character of a person performing skateboarding or snowboarding.

11. The game machine according to claim 1, wherein
the signal output part includes,
an electrostatic sensor configured to output a signal in accordance with the operation position of the operation to the operation part; and
a strain resistor configured to output a signal in accordance with the magnitude and the direction of the load applied to the operation part.

12. A non-transitory computer-readable recording medium storing a game-machine program used for a game machine, comprising:
an operation part that includes an operation surface on which an operation is performed by an operator;
a signal output part configured to output an output signal in accordance with an operation position to which an operation is performed on the operation surface, and a magnitude and a direction of a load applied to the operation part;
an operation-position detector configured to detect the operation position in accordance with one or more of output signals, each being the output signal, output from the signal output part; and
a load detector configured to detect the magnitude and the direction of the load applied to the operation part in accordance with one or more of the output signals output from the signal output part, and
the game-machine program causing a computer connected to the signal output part to:
function as a processor configured to calculate a state of an object arranged in a game space, wherein
the processor is configured to calculate a next state of the object in accordance with the operation position detected by the operation-position detector, the magnitude and the direction of the load detected by the load detector, and the state of the object by referring to control data associating operation contents of the operator with the state of the object.
